(19) United States
(12) Patent Application Publication
(10) Pub. No.: US 2019/0332400 A1
(43) Pub. Date: Oct. 31, 2019

(54) SYSTEM AND METHOD FOR CROSS-PLATFORM SHARING OF VIRTUAL ASSISTANTS

(71) Applicant: Hootsy, Inc., Fairport, NY (US)

(72) Inventors: Daniel Spoor, Fairport, NY (US); Jason DeVries, Lansing, MI (US)

(73) Assignee: Hootsy, Inc., Fairport, NY (US)

(21) Appl. No.: 16/397,270

(22) Filed: Apr. 29, 2019

Related U.S. Application Data
(60) Provisional application No. 62/664,451, filed on Apr. 30, 2018.

(51) Int. Cl. G06F 9/451; G06F 9/54; G06F 16/23; G06F 3/16; G06F 3/01

(52) U.S. Cl. CPC G06F 9/453; G06F 9/54; G06F 3/04815; G06F 3/167; G06F 3/013; G06F 16/2379

(57) ABSTRACT

Systems and methods are disclosed to facilitate the creation, storage and display of virtual assistants in a scene of a display system operatively associated with a computer-based virtual reality or augmented reality system. Further disclosed are embodiments facilitating the creation and use of multiple assistants within a display scene, as well as the ability to associate and track users' interactions with one or more of the plurality of assistants.

This application claims priority under 35 U.S.C. § 119(e) to U.S. Provisional Patent Application No. 62/664,451 for CROSS-PLATFORM SHARING OF VIRTUAL ASSISTANTS, by D. Spoor et al., filed Apr. 30, 2018, which is hereby incorporated by reference in its entirety.

An application programming interface is disclosed that provides a system and method to facilitate the cross-platform sharing of virtual assistants in a displayed scene (e.g., virtual reality (VR), augmented reality (AR), etc.).

### BACKGROUND AND SUMMARY

A challenge for ad-based revenue services such as Google® is that the world is quickly moving towards voice-based interactions and 3D experiences. How do such revenue services maintain their dominance in digital advertising as the world moves towards these new mediums? As an example, consider the current battle of voice interactive home devices (i.e. Amazon Echo, Google Home, Apple Homepod, etc.). These physical devices will become obsolete in the future as people transition to devices like augmented reality (AR) glasses that allow for a similar, hands-free experiences without the need for a stationary device. The question is what will advertising look like in this new reality where users interact primarily through AR devices and not 2D screens or physical devices?

In such virtual reality (VR) and augmented reality (AR) scenarios there are two main requirements: i) the way in which users interact with the advertisement must feel as natural as how they interact with other elements of the AR scenario; and ii) the entire interaction must be in 3D. The most natural way to interact with a computer-driven assistive feature in AR is the same way a user would interact in the real world, for example, with our hands, eyes and voice. Voice in particular provides the widest range of potential interactions and so it will become the dominant form of interaction in AR.

The experience must also stay in 3D. Clicking an ad on a website to display a new website may be acceptable on a web browser, but in AR it is anticipated that the interaction will need to be much more immersive. Trying to overtake the user's view with 2D content would be jarring. Even more so, trying to make significant changes to the 3D environment will feel obtrusive in the AR scenario. As a result, the advertisement function must rely on voice interaction and minimal 3D content to accomplish its goal. As an example, if Pizza Hut® wants you to order pizza, Amazon℠ wants you to order an item, or Marriott® wants you to check out one of their hotels, they must do so while respecting your need for personal space. Virtual assistants built specifically for VR and AR scenarios can meet these requirements. Such assistants can provide natural voice interactions, they can be positioned anywhere within a scene/display, and they can be designed to focus on solving a specific task extremely well. Virtual assistants can have an appearance that is specific to a certain brand, and display minimal visuals solely to make it clear what their purpose is and to help guide an interactive conversation. Finally, virtual assistants in accordance with the disclosed embodiments can be easily embedded in other AR experiences because they are singular 3D objects.

The systems and methods disclosed herein facilitate companies and developers building virtual assistants into their 3D interactive environments. Furthermore, aspects of the disclosed embodiments enable connections between companies with developers and 3D designers to build out their AR experience. Moreover, the concept of sharing the assistants facilitates the embedding of multiple, different virtual assistants into one experience or app.

Referred to herein as Hootsy® the application programming interface (API) facilitates the creation of virtual assistants for VR and AR that can be added to an app (application), site or game. In many computer-driven scenarios, voice interactions (when done well) are the most natural way for a user to interact with the computer-based system, and the Hootsy API makes it easy to create and share virtual assistants in a manner to facilitate interaction by means other than conventional keyboards and pointing devices (e.g., mouse, touchpad, etc.).

Think of voice-responsive assistants like a virtual Amazon® Echo™ that can be positioned anywhere within a scene, but unlike the general purpose Echo, it focuses on helping users solve a specific task extremely well, and uses visuals to make this easier and more engaging.

Disclosed in embodiments herein is a computer-implemented method for displaying a plurality of virtual assistants on a display via an application programming interface, comprising: displaying, within a scene, at least one computer-implemented virtual assistant responsive to voice (audio) commands from a user viewing the scene, wherein at least said virtual assistant is implemented by a first display system including a processor and a memory, with computer code instructions stored thereon, where the processor and the memory are configured to implement the virtual assistant and respond to a user request to initiate dialog with the virtual assistant, said virtual assistant being selected from a database of created virtual assistants, wherein the virtual assistant is a predefined virtual assistant having a unique identifier, and for which a virtual assistant model and associated interaction details are stored in the memory and associated with the database, and where usage of the predefined virtual assistant by the display system is controlled in response to information stored in said database (e.g., list of approved apps/sites where virtual assistant can be invoked, assistant details), updating the database to track usage of the virtual assistant by each display system, wherein tracking usage includes recording, in the database, each virtual assistant occurrence and the assignment of each virtual assistant occurrence; associating a navigation object (target area) to the at least one computer-implemented virtual assistant responsive to voice (audio) commands, wherein the navigation object is configured to be responsive to at least one predetermined user viewing condition (e.g., ray from user's view intersects with target area); and detecting when the user is intending to interact with (e.g. looks at) the at least one computer-implemented virtual assistant responsive to voice (audio) commands, and upon detecting the intent to interact, enabling the receipt of the user's voice command(s) by the display system.

### BRIEF DESCRIPTION OF THE DRAWINGS

FIGS. 1-2 are exemplary representations of virtual or augmented reality interface displays or scenes in accordance with an aspect of the disclosed embodiments;

FIGS. 3-4 are exemplary representations of user interface displays relating to the creation or building of virtual assistants in accordance with an embodiment of the disclosed system and method;

FIGS. 5-9 are representation of various architectural elements and interactions therebetween in accordance with a disclosed embodiment;

FIGS. 10-17 are exemplary illustrations of various features and functions of a virtual assistant and associated options in accordance with the embodiments and methods disclosed;

FIGS. 18A-18I are illustrative examples of a scenes depicting a series of interactions between a virtual assistant and a user in accordance with the disclosed embodiments;

FIG. 19 is block diagram of a system for implementing the virtual assistant method using a general purpose computing device;

FIG. 20 is an illustrative flowchart depicting an exemplary method of employing the virtual assistant;

FIG. 21 is an illustration of details of an interaction boundary in accordance with an alternative embodiment;

FIG. 22 is a block diagram illustrating an exemplary architectural arrangement of clients, servers, and external services, according to an embodiment of the invention;

FIGS. 23A-23B and 24A-24B are illustrative examples of scenes depicting a series of interactions between a virtual assistant and a user to illustrate an alternative context management function; and

FIGS. 25A-25B are illustrative examples of scenes depicting an attachment function for the virtual assistant in accordance with the disclosed system and method.

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

The terms API and Webhook have been used herein in a generally interchangeable fashion, although it will be appreciated that one difference is when using an API to get data from a server, the client requests the data and the server sends it back. Thus, the client is not aware if there is new data or of the status of the information on the server until it makes such a request. Webhooks, on the other hand rely on the server knowing what information the client needs, and sending it to the client as soon as there is a change in the data. In response the client sends an acknowledgement that the request was received and that there is no need to try to send it again. In one sense, webhooks are more efficient in that they do not require that repeated client requests be handled by the server so that an API can determine if data has changed.

Although the following description will at times refer to either virtual reality (VR) or augmented reality (AR), there is no intent to limit the disclosure to one or the other, and in most cases the disclosed embodiments are applicable to both VR and AR applications.

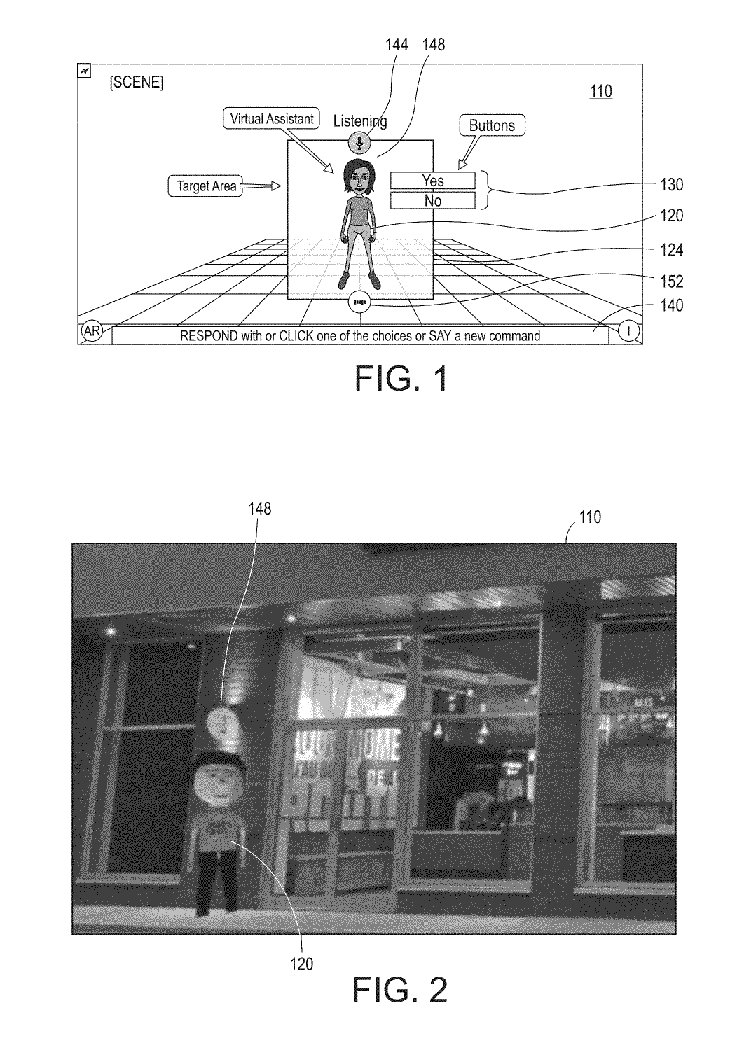

Referring to FIGS. 1 and 2, depicted therein are examples of a virtual assistant in a displayed scene 110. In FIG. 1, the scene 110 is depicted without background in order to focus on the virtual assistant object 120 and other elements of the scene such as the rectangular target area 124 about the virtual assistant object. Also included in the scene are user-selectable objects such as “yes” and “no” buttons 130. In one embodiment, the scene may include other user prompts such as an instruction bar 140, a mode or status indication field 144 (displaying “Listening”), a graphic or icon 148 indicating the user status for the (e.g., the microphone is “on” (a color such as the color green in the background is used to indicate the microphone status—depicted as shaded to indicate “listening”) and the user's voice input is being received and processed by the assistant). Below the assistant object is the assistant status icon 152, showing a graphic representation of the virtual assistant's status (e.g., the a varying waveform in the status area indicates that the assistant is receiving an audio input (the user's speech)).

As is apparent by a comparison of FIGS. 1 and 2, FIG. 2 includes a scene 110 as may be observed by a user in a VR or AR scenario, where the virtual assistant object 120 is presented in the context of a realistic background, which may be the environment in which the user is presently engaged.

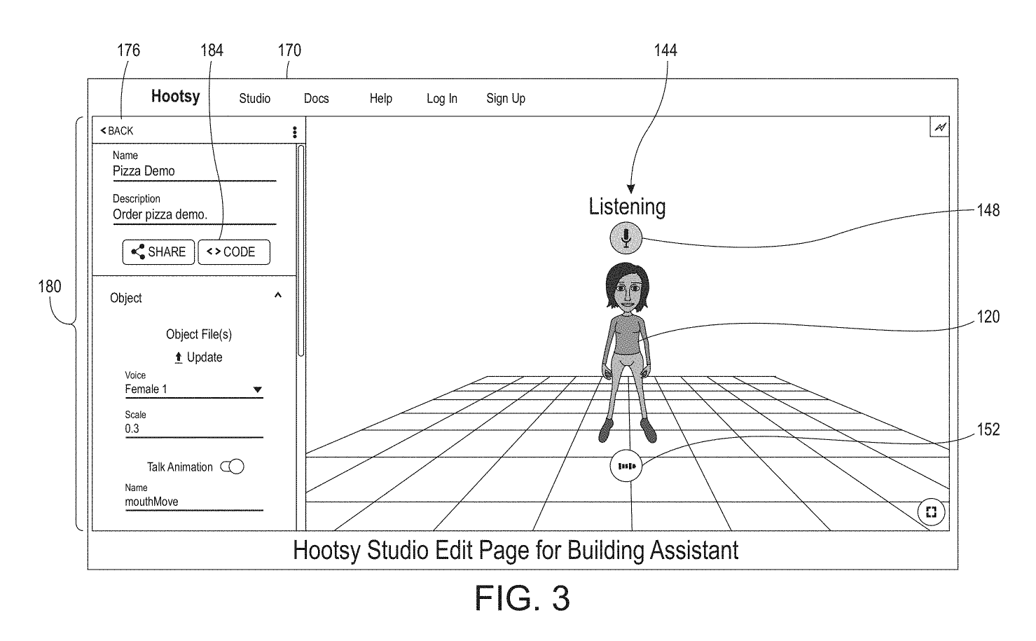

Referring next to FIG. 3, depicted therein is an exemplary interface for building a virtual assistant. As an example, say Yelp™, the popular app for finding reviews on nearby restaurants, shops, and entertainment, wishes to build an AR experience with virtual assistants. They want one virtual assistant to represent their brand and they may want a plurality of virtual assistants to represent places that they provide reviews of. To construct a virtual assistant the developers would use the Hootsy® system to build the Yelp assistant. They would define its appearance 120, voice, idle and talk animations, and connect it to a conversation engine built with a tool such as those available from Dialogflow.com. Dialogflow™ handles the natural language understanding used to determine a user's intent from spoken word, and can send back messages in a desired format for the Hootsy system to respond to in the scene, including display buttons, additional models and other visuals.

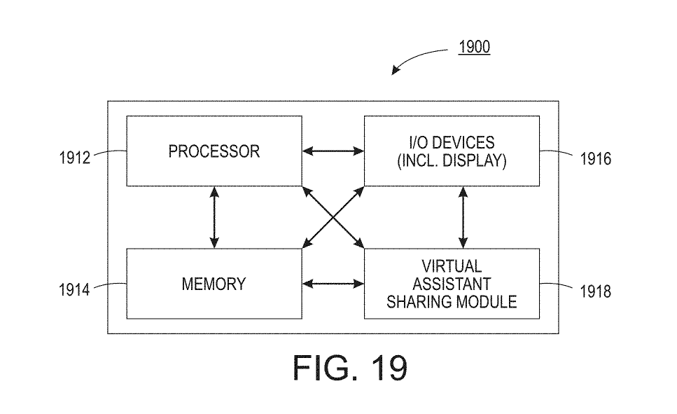

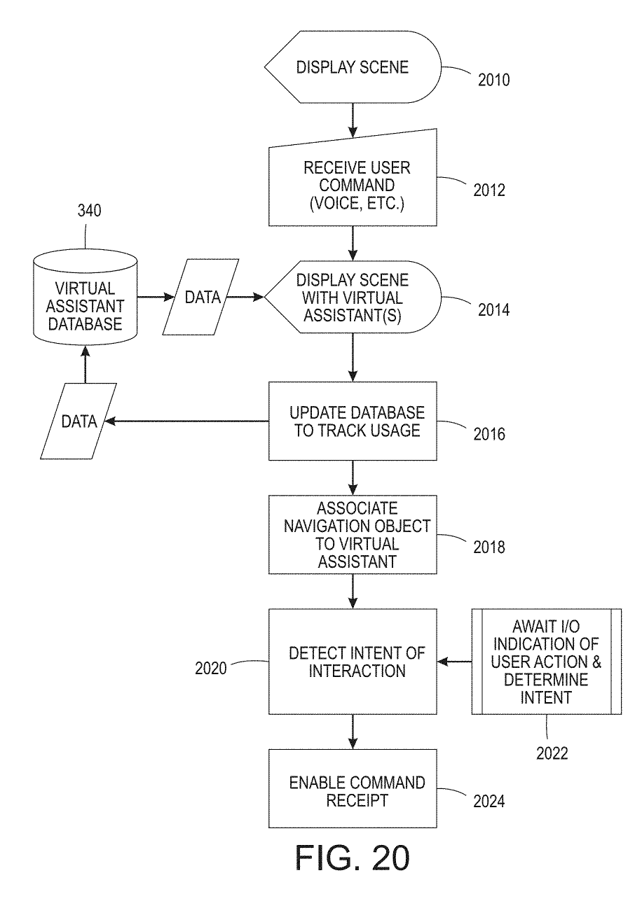

As used herein the term Hootsy is intended to characterize a networked server(s) operating on one or more computer processors under the control of programmatic code accessible to the computer processors, such as the system depicted in FIGS. 19 and 20. In FIG. 19 is a block diagram depicting an exemplary architecture for implementing at least a portion of the Hootsy system on a distributed computing network. According to the embodiment, one or more clients 330 may be provided access. Each client 330 may run software for implementing client-side portions of the disclosed embodiment, and the clients may comprise any of various types of computing systems, from smartphones, personal digital devices such as tablets, workstations and both VR and AR systems. In addition, any number of servers 320 may be provided for handling requests received from the one or more clients 330. Clients 330 and servers 320 may communicate with one another via one or more electronic networks 310, which may be in various embodiments any one or a combination of the Internet, a wide area network, a mobile telephony network, a wireless network (e.g., WiFi), a local area network, or any of various network topologies. Network(s) 310 may be implemented using any known network protocols, including for example wired and/or wireless protocols.

In addition, in some embodiments, servers 320 may call external services 370 when needed to obtain additional information (e.g., Dialogflow.com), or to refer to additional data concerning a particular call. Communications with external services 370 may take place, for example, via one or more networks 310. In various embodiments, external services 370 may comprise web-enabled services related to or installed on the hardware device itself. For example, in an embodiment where client-level VR or AR applications are implemented on a portable electronic device, client applications may obtain (receive) information stored in a server system 320 in the cloud or on an external service 370.

In some embodiments, clients 330 or servers 320 (or both) may employ one or more specialized services or appliances that can be deployed locally or remotely across networks 310. As an example, one or more databases 340 may be used by or referred to by one or more of the Hootsy system embodiments. It will be understood by one of skill in the art that databases 340 may be arranged in a wide variety of architectures, and may use a wide variety of data access and manipulation means. For example, one or more databases 340 may comprise a relational database system using a structured query language (SQL), while others may comprise an alternative data storage technology. Indeed variant database architectures may be used in accordance with the embodiments disclosed herein. It will be further appreciated that any combination of database technologies may be used as appropriate, unless a specific database technology or a specific arrangement of components is enabling for a particular embodiment herein. Moreover, the term “database,” as used herein, may refer to a physical database machine, a cluster of machines acting as a single database system, or a logical database within an overall database management system. Unless a specific meaning is specified for a given use of the term “database” herein, the term should be construed to mean any of these senses of the word, all of which are understood as a plain meaning of the term “database” by those of ordinary skill in the art.

Similarly, several of the disclosed embodiments may make use of one or more additional systems such as security system 360 and configuration systems 350. Security and configuration management are common information technology (IT) and web functions, and some amount of each are frequently associated with any IT or web-based systems. Additionally, in various embodiments, the functionality for implementing systems or methods of the disclosed embodiments may be distributed among any number of client and/or server components. For example, various software modules may be implemented for performing various functions in connection with the Hootsy Studio features (for creation of virtual assistant objects) and Hootsy system assistant database(s) and tracking, Hootsy server-side scripts, etc., and such modules can be variously implemented to run on server and/or client components.

Within the Hootsy system's virtual assistant studio window 170, a sub-menu 176 of assistant defining characteristics 180 is available for developer selection. The characteristics include, for example, a name (text field), description (text field), a defined object file for the assistant visual representation (e.g., from an uploaded file defining the 3D model and its visualization, for example, GLTF, FBX, and Collada), a voice type selected for assistant verbal output (female 1-N or male 1-N), a scale factor (characterizing the size of the assistant object file relative to the displayed scene (0.1-1.0, where 1.0 would be a full width or height within the scene), a selector for talk animation (on/off), and the selected animation type to accompany verbal/speech output (e.g., mouth move, hands moving, head nodding, etc.), etc. (see details in Table A below). It should be further appreciated that these are only some of the core features that can be defined by a developer using the Hootsy Studio website, and the feature settings may be saved in the assistant database. As an alternative, it is also conceivable that the developers may be provided with code that will allow them to fully customize the appearance of the assistant beyond the core feature settings. As an example, the embodiment illustrated in FIG. 3 includes a mic icon (graphic or icon 148) displayed above the assistant. If a developer does not want icon 148 displayed, they could remove it in their code even though there isn't a setting for including/excluding the icon in the Hootsy Studio interface.

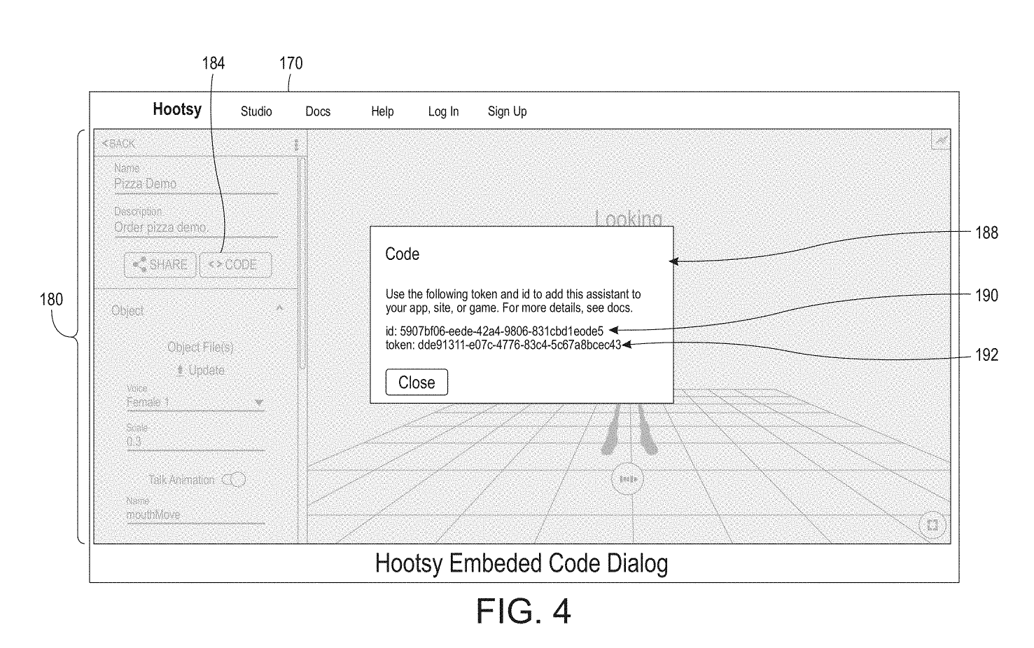

Referring also to FIG. 4, once complete, the developer would select the ‘Code’ button 184, which results in the display of a dialog box 188 with an Object ID specific to that assistant and a token specific to their account. This Object ID 190 and token 192 are then available, both as strings of characters, for subsequent use to embed the assistant into any AR or VR experience.

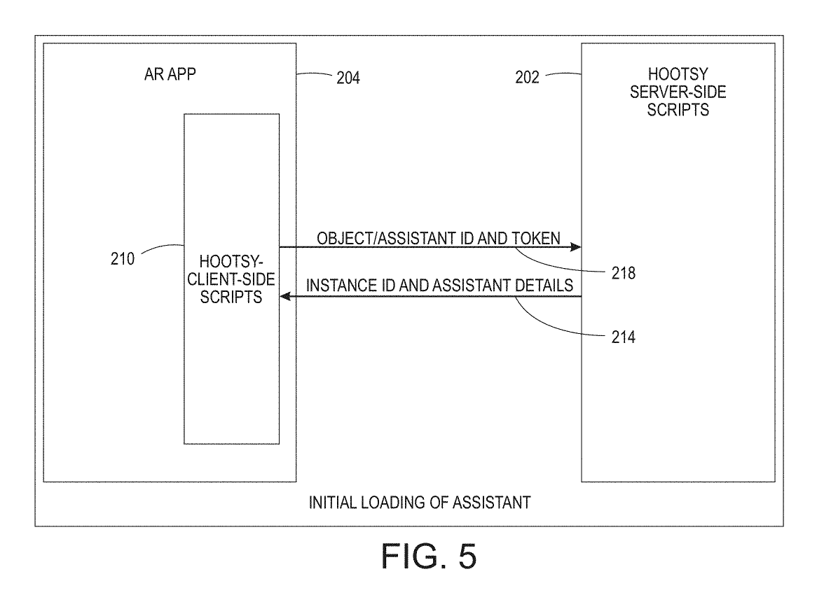

Also referring to FIGS. 5-9, in response to the “code” request, the Hootsy system's interface 202 provides the developer with the client side scripts 210 (minified and obfuscated) that they add to their code. When the developer wishes to load the assistant, they pass the ID and token to these scripts (see 214). Doing so generates an instance ID 218. This instance ID uniquely identifies each instance of the virtual assistant in a scene for each user visiting the website or running the native app. The instance ID is associated with the website URI or native app ID, the virtual assistant's ID, the user's ID, and an instance number. Using such information the website URI or native app ID distinguishes where the virtual assistant is being used, thereby allowing for the management and tracking of a plurality of virtual assistants. Each virtual assistant's ID distinguishes the type of virtual assistant that is being used. Furthermore, the user's ID distinguishes the user that is interacting with the virtual assistant. The instance number distinguishes one instance of a particular type of virtual assistance from another of the same type. This allows handling of multiple different conversations with different assistants. As an additional control feature, the token is used to control whether the creator of the VR or AR experience (e.g., AR App 204) should be able to add this assistant. If they are violating any Hootsy system terms, it is possible the system can prevent them from adding assistants to their app.

For each interaction between the user and assistant, the instance ID is passed to the Hootsy system's server-side scripts 202. This allows the Hootsy system to track all interactions and provide usage data back to the creator of the VR or AR app or creator of that specific assistant. This includes data like number of interactions for a specific site or app, number of interactions per user, number of interactions for a specific location, etc. This also allows an advertising model where the creator of the assistant pays Hootsy and/or the creator of the VR or AR app for those interactions. Also important to note is that while described relative to voice interactions, interaction details sent to the Hootsy system's server-side scripts are not specifically limited and can include actions like clicking a button displayed next to the assistant (e.g., FIG. 1; 130). Hootsy system functionality is also not limited to notifying the server scripts of just user interactions, but may also send details such as when the assistant is done speaking.

Consider, for example, that Yelp has added their own assistant to their own AR experience. This assistant helps users discover nearby restaurants and other places of interest. Next, they want to include the ability to include any available virtual assistants that are specific to the businesses they are recommending. These businesses are represented by assistants created by other people/companies. For example, say Yelp wishes to add a Pizza Hut® assistant to allow users to order pizza. At the same time Yelp or other referring entity would be providing themselves a way get paid by Pizza Hut for promoting their business and directing customers. There are a couple ways this functionality can be accomplished:
1. Find the specific assistant(s) they want to use and pass in that ID and their account token similar to their Yelp assistant; or
2. Send details to Hootsy system's server side scripts that allow the Hootsy system to select the best assistant for display in the user's scene. This can include (but is not limited to) key terms like ‘pizza hut’ or the user's location data for the Hootsy system to determine that the user is near a Pizza Hut. Notable, this latter option contemplates business and creators of virtual assistants competing to have their assistants display in certain user scenarios—in a manner similar to how companies bid for ad placement on Google.

The latter approach is important as it allows the Hootsy system to build an intelligent system for selecting the desired or appropriate virtual assistant for that experience. Assistants that would provide the best experience to the user and that would provide the highest revenue for the Hootsy system and/or the creator of the VR or AR experience.

Once multiple assistants exist in the app, the client side scripts 210 determine which virtual assistant a user is interacting with based upon criteria such as which assistant he or she most recently looked at. To determine which assistant the user looks at, the system employs one or more functions such as gaze direction or other monitoring of the user's eye position to assess whether the gaze is directed at an assistant's target area 124. The gaze information is obtained as an input to the Hootsy system's client-side scripts 210 directly from the VR/AR app 204. For example, the Hootsy system's client-side scripts may project a virtual ray from the center of the system's screen. When the ray intersects an assistant, the Hootsy system will determine if the user is intending to interact with that assistant. If so, the Hootsy system's client-side scripts will trigger that assistant to start listening to voice commands, and trigger any other assistants to stop listening. All future interactions will use that assistant's instance ID when sending messages to the Hootsy system's server-side scripts. Context is retained for all conversations so if the user is talking to assistant “A”, switches to assistant “B” and then switches back to assistant “A”, the conversation with assistant “A” will continue where it left off.

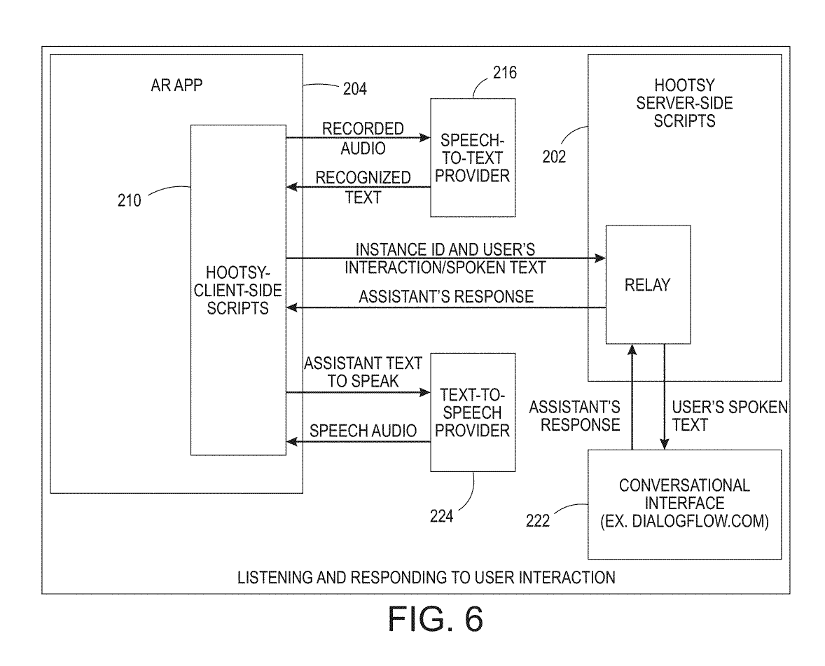

As represented in the diagram of FIG. 6, there are various techniques that may be employed with respect to any of the exchanges between a VR or AR user and a virtual assistant in accordance with the disclosed system and methods. For example, in order to receive a user's query or command, the assistant first “listens” meaning that the client-side script receives and records an audible input from the user. The recorded audio is processed by a speech-to-text function 216 that can be part of the client-side applications, or a service accessed by the client. In response, the Hootsy system's client-side scripts 210 receive the recognized text and pass the spoken text as data along with the assistant's instance ID and other interaction information to the Hootsy system's server-side script 202 operating on the server (e.g., FIG. 19, 320). In one embodiment the server-side script relays the user's spoken text to a conversational engine or external service 222 (e.g., Dialogflow.com) which interprets the user's spoken text and returns or responds with the assistant's programmed response as a text string. The assistant's response is then relayed back to the client-side script, where, using the text-to-speech engine or service 224, the client-side script receives the speech and is able to output it to the user in form of an audio response. In addition to the exemplary flow of data as depicted in FIG. 6, the client-side or server-side scripts, in association with the related apps are able to parse and process the recognized user text to determine the extent to which such speech included commands such as response, selections and the like.

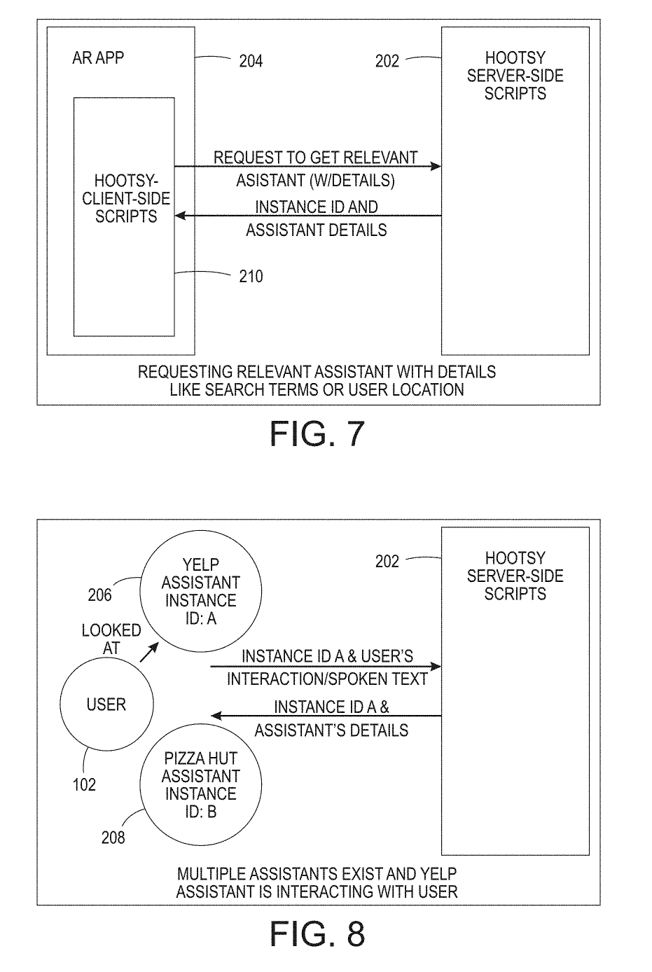

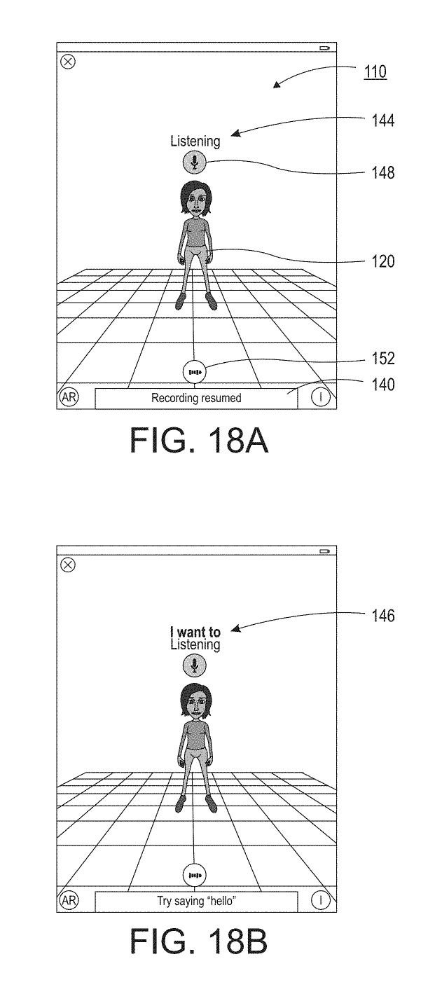

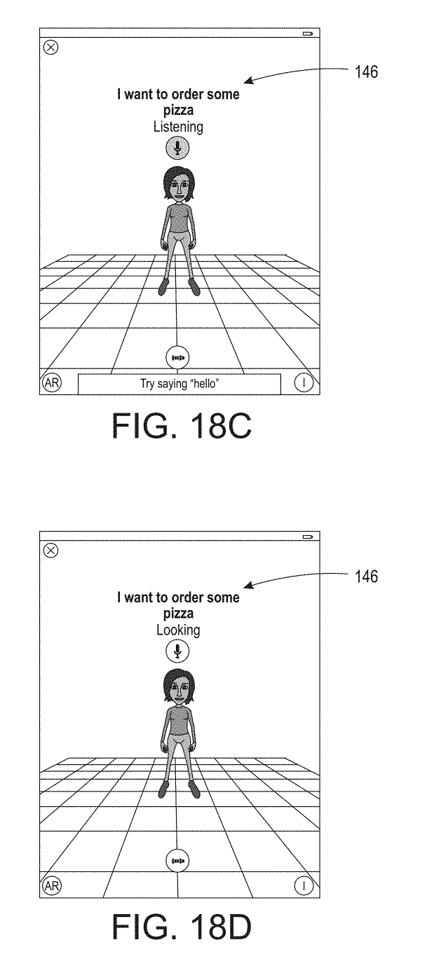

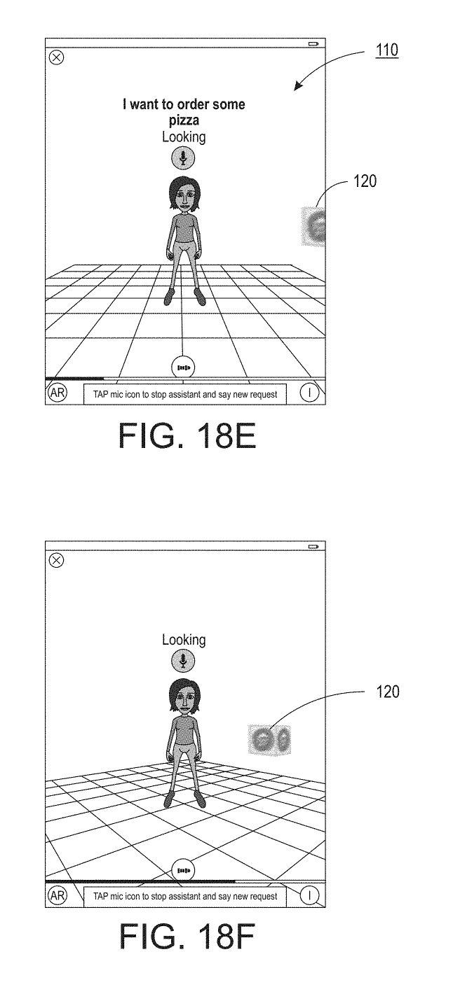

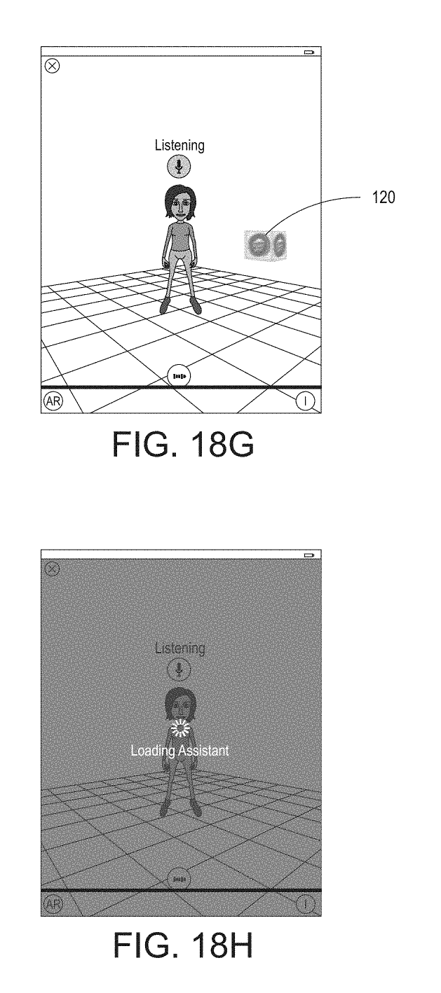

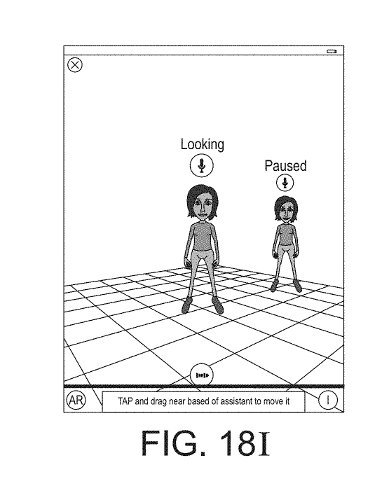

In FIG. 7, the diagram is intended to illustrate the exchange of data between the client-side and server-side scripts that facilitates a request for a relevant assistant. For example, one or more user commands or queues (verbal, visual or manual selection) may be received and interpreted by the client-side script as a request for an assistant. Furthermore, additional information providing context such as search terms, location, etc. may be processed in order to identify the relevant assistant. As in the example above, a user's request for a restaurant, combined with location, or other user preferences, may result in the scripts initiating a “Pizza Hut” assistant as described above (see FIGS. 18A-18I).

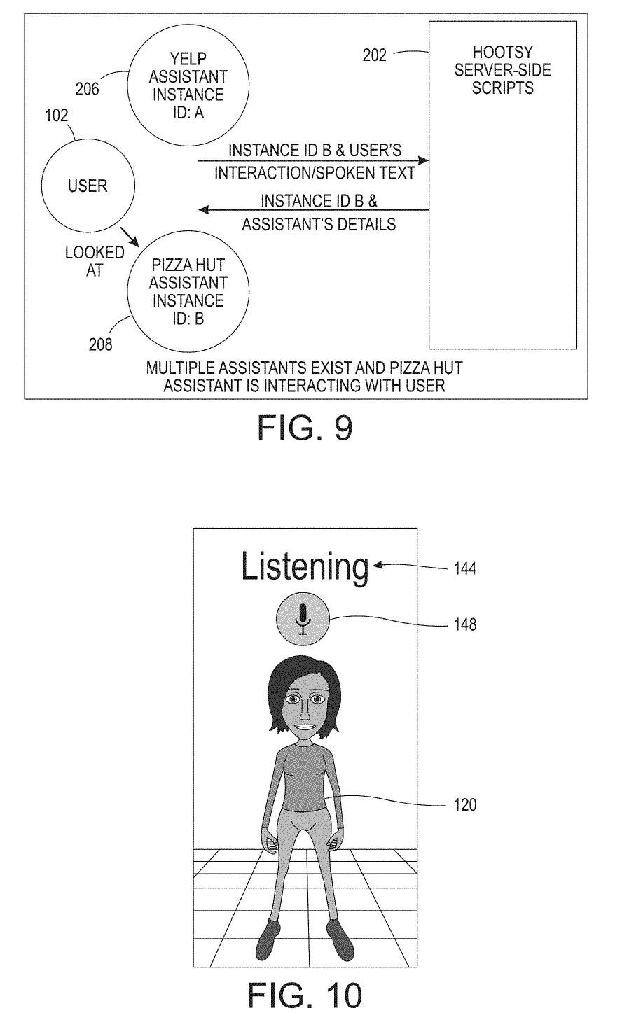

FIGS. 8 and 9 provide an example in which multiple virtual assistants (206, 208) are active in a scene. Based upon the user's gaze, an indication that the user looked at Yelp assistant A (206) or Pizza Hut Assistant B (208) is used to direct the interaction such as the user 102's spoken text to the server side scripts, along with the appropriate instance ID for the assistant to which the user's interaction was directed. As will be appreciated, in a scene including a plurality of assistants, part of the context necessary to process user input is information relative to which assistant the user interaction was directed. This will be further described relative to the Context Manager as described below.

In light of the discussion presented herein, it should be appreciated that the disclosed system and methods, which may be implemented in conjunction with a VR or AR system display, facilitate the development and interactive features of multiple virtual assistants for one or more users interacting in a scene. One of the embodiments is directed to the computer-implemented method for displaying multiple virtual assistants on a display (via an application programming interface, webhook, etc.). Such a method, as generally represented by the flowchart of FIG. 20, includes initially displaying a scene (2010) and in response to a user's command (2012) (e.g., voice or keyboard command), displaying, within the scene, at least one computer-implemented virtual assistant responsive to voice (audio) commands from a user viewing the scene (2014). The virtual assistant is implemented by a VR or AR display system including a processor and a memory, with computer code instructions (e.g., VR or AR app) and is configured to implement the virtual assistant and respond to user requests in the form of dialog with the virtual assistant. Moreover, as described, the virtual assistant may be selected (instance ID & token) from a database of pre-existing virtual assistants created by a developer (e.g., virtual assistant database 340). Each virtual assistant is predefined and has a unique identifier, and each virtual assistant includes, among other features, a selected model or object and associated interaction details that are stored in the memory associated with a database(s) (e.g., database 340). Usage of the predefined virtual assistant by the display system is controlled in response to information stored in the database (e.g., list of approved apps/sites where virtual assistant can be invoked, assistant details). Updating the database is performed by the server-side app to track usage of the virtual assistant by each display system, and the tracking includes recording, in the database, each virtual assistant's occurrence and an assignment of each virtual assistant occurrence (2016). The method also includes associating a navigation object (e.g., a target area) to the virtual assistant (2018), where the navigation object is configured to be responsive to at least one user viewing condition (e.g., ray from user's view or gaze intersects with the target area) as represented by operation 2022. And, detecting when the user is intending to interact with (e.g. looks at) the virtual assistant so as to be responsive to voice (audio) commands (2020). Upon detecting the intent to interact by a user the method enables receipt of the user's voice command(s) by the system (2024).

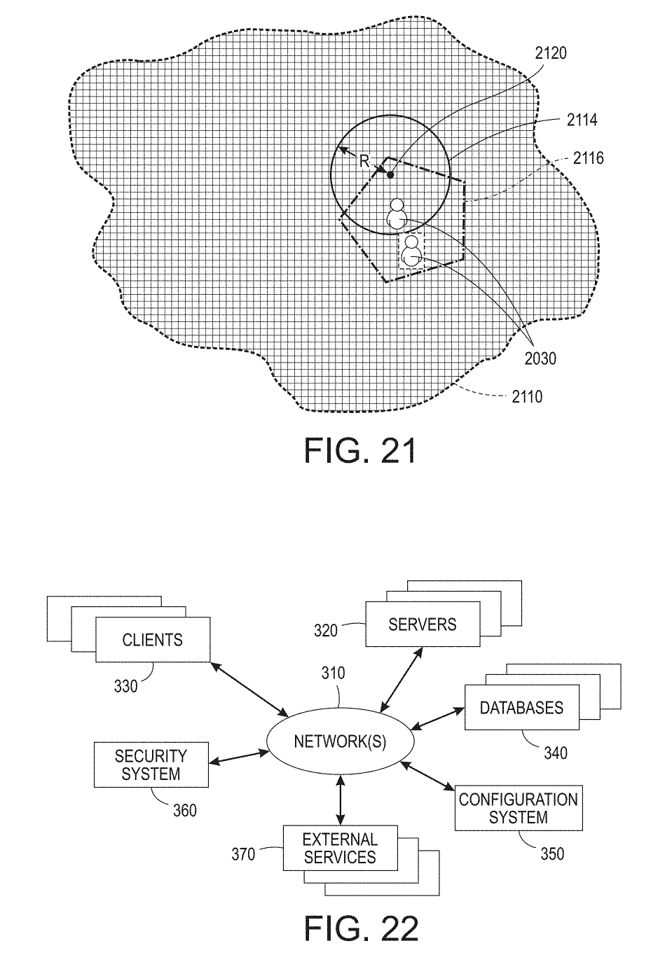

Another factor that may be employed with regard to operations 2020 and 2022 above, where the system monitors and detects an intention of the user to interact with the virtual assistant, is an interaction boundary. For example, when a user is within the interaction boundary the system awaits the user's command, but when the user is outside of the interaction boundary, the system is not in a mode of awaiting each command. Doing so potentially reduces the use of system resources associated with the virtual assistant at times when the user is not in proximity to the virtual assistant—at least relative to the virtual or augmented reality scene. Referring to FIG. 21, depicted therein is an exemplary illustration of the interaction boundary from a top-down perspective view. In a VR/AR area 2110, the user may have initiated the virtual assistant at a point 2120, and upon doing so the virtual assistant has a coordinate location for point 2120 assigned to the assistant. It will be appreciated that various coordinate systems, and actual (e.g., global positioning system (GPS)) or similar coordinates may be used, or a relative system may be employed (e.g., relative to the area 2110). Moreover, while a circular interaction boundary 2114 is shown, it will be appreciated that alternative shapes 2116 and/or adjustable settings (e.g., radius) may be included with the interaction boundary functionality.

In the illustrated embodiment of FIG. 21, if the user 2030 is at a position inside or along the interaction boundary 2114, for example a radius “R” about the assistant's point 2020, then the virtual assistant remains active. The distance R may be a predefined value (e.g., 15 meters), or may be programmable, perhaps based upon the scene/area, or even user-adjustable. The distance R may take a range of values relative to the coordinate system, and a setting of the maximum value may signal that the interaction boundary function is disabled and the assistant remains active no matter the user's separation from the assistant. When the user 2030 moves outside of interaction boundary 2114 (i.e., beyond radius R), the system may suspend the process of awaiting further interaction with the virtual assistant. In the alternative interaction boundary represented by 2116, the boundary may be a shape that is moved or oriented toward the user (or even about the user), and thereby shifts to some extent as the user moves about the area 2110.

As will be appreciated, aspect of the disclosed method and system permit the creation and storage of various assistant objects, particularly where the virtual assistant may be selected from an object, or an avatar. Moreover, the database of virtual assistants, as noted previously, includes at least one predefined virtual assistant and where each assistant is identified by a unique identifier including: an instance ID associated with the display system (e.g., website URI or native app ID), a virtual assistant's ID, a user's ID, and/or an instance number, and for each occurrence a virtual assistant model and associated interaction details are stored in memory. Using the stored information wherein multiple virtual assistants are displayed within the scene, particularly where at least a portion of the plurality of virtual assistants are from a plurality of sources, each of the virtual assistants displayed in the scene are associated with a user's ID in said database so that it remains possible to associate the user's interaction with a particular assistant. And, the method is able to track the exchange of communications (e.g., user commands and responses) between each of the virtual assistants within a scene and their respective users.

As noted, for example relative to FIGS. 18A-18I, in response to the user's voice command, the method is suitable for displaying within the scene of the display system, a visual object relating to the system's response to the user's voice command. For example, the disclosed embodiments can detect when a user is intending to interact with (e.g. looks at, selects, etc.) a visual object associated with an assistant (second assistant, buttons, scrollable carousel, etc.), and upon detecting the intent to interact the visual object, indicating the visual object as a user input to the system. FIGS. 18A-18I are described in further detail below.

Having generally described the use and functionality of virtual assistants created using the Hootsy system's webhooks/API, attention is now turned to a more detailed discussion of methods by which a virtual assistant can be created, how a conversation is defined for the virtual assistant, and how a webhook/API can be employed to define how developers choose to have the assistant respond to different user requests or similar input scenarios.

Assistants

An assistant consists of a character and a conversation. The character defines what the assistant will look like, and the conversation defines how users will interact with the assistant.

Character—A simple character creator is available to make it easy to customize one of our existing characters. You can also build and upload your own character, for example, with 3D animation software like Blender (www.blender.org) or Maya®.

Character:

TABLE A

| | | Default |
|---|---|---|
| Property | Description | Value |
| Source | Source of character files. | Character |
| | | Creator |
| File(s) | Required if source is set to | |
| | Uploaded. Must be a FBX, | |
| | GLTF or GLB file. Include any | |
| | supporting texture or bin | |
| | files. | |
| Voice | Voice of the character | English (US), |
| | | Joanna |
| Scale | Default size of the character | 1 |
| Talk Animation | Set to yes if visime blendshapes | yes |
| Enabled | are defined for the character | |
| Visime | Set to the blendshapes corre- | |
| Blendshapes | sponding to each visime. | |
| Blink Morph | Set to yes if a blink blend- | yes |
| Animation | shape is defined for the character | |
| Enabled | | |
| Blink | Set to the blendshape corre- | Blink |
| Blendshape | sponding to an eye blink. | |
| Blink Duration | The amount of time for the | 500 |
| (ms) | eye blink animation to complete. | |
| Blink Animation | Sets the minimum amount of | 1000 |
| Random Min | time in milliseconds to wait | |
| Timeout | to run animation. | |
| Blink Animation | Sets the maximum amount of | 5000 |
| Random Max | time in milliseconds to | |
| Timeout | wait to run animation. | |
| ‘TBD’ | Each animation defined in | false |
| Animation | the character files can be | |
| Enabled | enabled. | |
| ‘TBD’ | Set to Continuous to have | On Request |
| Animation | animation play continuously | |
| Repeat | on loop. It'll only stop when | |
| | an on-request animation is played. | |
| | Set to Random to have the | |
| | animation play at random intervals. | |
| | Set to On Request to trigger the | |
| | animation from a conversation | |
| | message. | |
| ‘TBD’ | Multiplies the animation timescale | 1 |
| Animation | by the speed value to make the | |
| Speed | animation play faster or slower. | |
| ‘TBD’ | If repeat is set to Random, this | 1000 |
| Animation | sets the minimum amount of time | |
| Random Min | in milliseconds to wait to run | |
| Timeout | animation. | |
| ‘TBD’ | If repeat is set to Random, this | 5000 |
| Animation | sets the maximum amount of time | |
| Random Max | in milliseconds to wait to run | |
| Timeout | animation. | |

As previously noted, one feature contemplated in the embodiments disclosed is the ability to easily make available and share virtual assistants. In the Hootsy system, aspects of this feature are enabled using a Gallery link, where a link to a demo for your virtual assistant can be shared with others by simply copying the URL in the address bar. In addition, to make it even easier to share your creation and for the community to build off each other's creativity Hootsy makes additional gallery settings available as detailed in Table B below:

TABLE B

| | | Default |
|---|---|---|
| Property | Description | Value |
| Allow Others to | This setting will display your object | false* |
| View in Gallery | in the Hootsy Gallery. | |
| Allow Others to | This setting allows others to embed | false* |
| Embed | your object into their site or app. | |
| Allow Others to | This setting allows others to create a | false* |
| Remix | copy of your assistant and adjust the | |
| | settings. They will not be able to | |
| | view your webhook and token, but they | |
| | can use it or override the settings. | |

*should only be set to “true” when the assistant is complete and would create a unique experience for others.

Embed

Once a virtual assistant has been created and tested the developer selects ‘Code’ on the object page. In response the Hootsy studio provides the ID and Token needed to add the assistant to your app, site or game.

In the case of a website, for example, the assistant can be added to a Three.js scene. A developer would add the Hootsy system's client scripts to their project (ex. <script type=https://hootsy.com/js/hootsy-core/v1></script>) and then make a call to the Hootsy system's assistant service with their token and ID.

let assistant=new HootsyAssistant(token, ID);

For native apps, a Unity™ plugin is provided. The developer would add the plugin code to their Unity project and then make a call to the Hootsy assistant service with their token and ID. This should be added as a component to a GameObject.

HootsyAssistant assistant;
assistant=new GameObject( ).AddComponent<HootsyAssistant>( ) as HootsyAssistant;
assistant.id=id;
assistant.token=token;

Conversations Overview

Integration of the Hootsy system's conversational bots is very similar to Facebook Messenger, Slack, and others.

Getting Started

Bots can be created in any service chosen, such as Dialogflow or Wit.ai. There are two integration approaches:
1. Default integration where the Hootsy system hosts the message relay code between the assistant and your chatbot.
2. Custom integration where you define a webhook to your message relay code.

Default Integration

This currently only works for chatbots created with DialogFlow. When using this approach, define the response in Dialogflow as a Facebook Messenger response. For custom payloads such as those used to define an additional model to display, set ‘hootsy’ as the message type as seen below.

{

“hootsy”: {

“attachment”: {

“type”: “model”,
“payload”: { }

}

}

}

Custom Integration

Custom bots can be created in any service that a developer chooses, like Amazon Lex, IBM Watson, etc. Custom integration allows the developer to perform additional actions before responding to a request.

Integration Steps:
1. Select one of your assistants in the Hootsy system.
2. Setup Webhook: In the Conversation section of your object on the Hootsy system, define your webhook URL.
3. Copy tokens: In the Conversation section of your object on the Hootsy system, copy the access and verify token and add it to your script.
   Ensure all messages are sent in the proper format as defined in the Conversations API.

Conversation Setup:

TABLE C

| | | |
|---|---|---|
| | | Default |
| Property | Description | Value |

| | |
|---|---|
| Name | Name of your conversation. |
| Integration | Select between Default and Custom. |
| Dialogflow | Required for default integration. |
| Access Token | Client access token defined for |
| | your agent in Dialogflow.com |
| Webhook | Required for custom integration. |
| Verify Token | Required for custom integration. |
| | Token used in your conversation |
| | code to authorize communication. |
| Access Token | Your auto-generated API access |
| | token used for custom |
| | integration. |
| Get Started | If defined, this message is |
| Message | sent the first time the |
| | assistant starts listening. |
| | This results in the assistant |
| | initiating the conversation. |
| | See the Get Started Message |
| | Section in the Conversations |
| | API |

Conversations API Reference

Webhooks

Webhooks enable apps to subscribe to (i.e., automatically receive) changes in certain pieces of data and receive updates in real time. When a change occurs, an HTTP POST request will be sent to a callback URL belonging to your conversation bot.

Format of message that the Hootsy system would send to a webhook:

{

object:“Message”,
entry:[{

id:“PAGE_ID”,
time:63624884710891,
messaging:[{

“sender”:{

“id”:“INSTANCE_ID”

},
“recipient”:{

“id”:“OBJECT_INSTANCE_ID”

},
“message”:{

“mid”:“mid.1457764197618:41d102a3e1ae206a38”,
“text”:“hello, world!”,

}

}]

}]

}

TABLE D

| Field Name | Description | Type |
|---|---|---|
| Mid | Message ID | String |
| Text | Text of message | String |

Send API

Described herein is by which responses are sent to the Hootsy system assistants which are then provided to users.

To send a message, make a POST request to https://ws.hootsy.com/api/send?access_token=<OBJECT_ACCESS_TOKEN> with the virtual assistant's access token. The payload must be provided in JSON format as described below:

curl -X POST -H “Content-Type: application/json” -d ′{

“recipient”: {

“id”: “INSTANCE_ID”

},
“message”: {

“text”: “hello, world!”

}

}′
“https://ws.hootsy.com/api/send?access_token=<OBJECT_ACCESS_TOKEN>”

Payload

TABLE E

| Property Name | Description | Required |
|---|---|---|
| recipient | recipient Object | Yes |
| message | message Object | Yes |

Message Object

TABLE F

| Property | Description | Required |
|---|---|---|
| text | Message text spoken by the object | text or |
| | | attachment |
| | | must be set |
| attachment | attachment object | text or |
| | | attachment |
| | | must be set |
| quick_replies | Array of quick_reply to be sent with | No |
| | messages | |
| metadata | Custom string that will be re-delivered | No |
| | to the webhook listeners | |

* text and attachment are mutually exclusive;
* text is used when sending a text message, must be UTF-8 and has a 640 character limit;
* attachment is used to send messages with images, models, or Structured Messages;
* quick replies is described in more detail in the Quick Replies section;
* metadata has a 1000 character limit

Content Types

Text Messages

Provides a simple text response (Table G) which is spoken by the object, for example virtual assistant object 120 in FIG. 10.

TABLE G

| Property Name | Description | Required |
|---|---|---|
| text | Message text spoken by the object | Yes |

* text must be UTF-8 and has a 640 character limit

Image Attachment

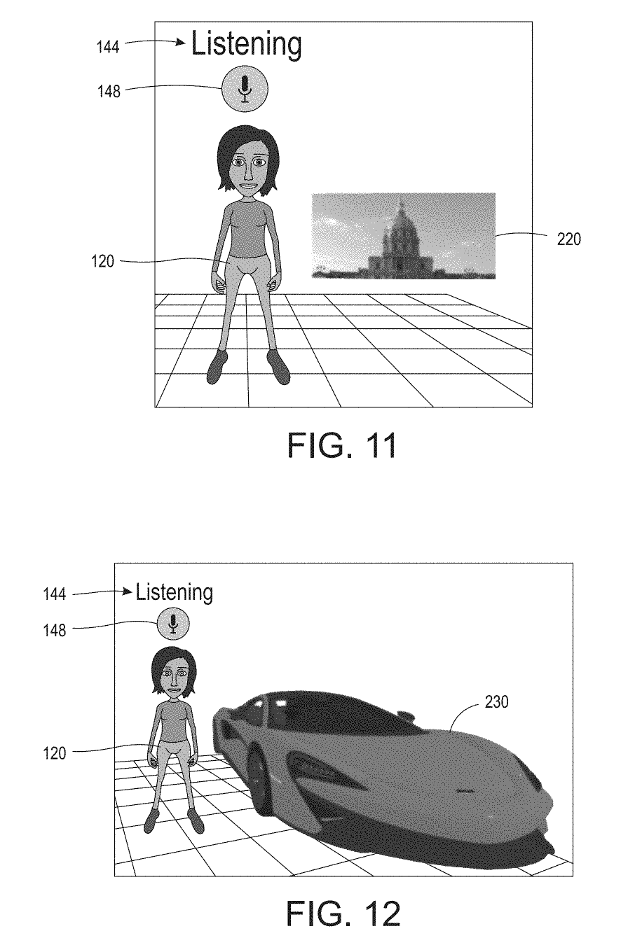

Provides an image 220 that displays next to the object 120, as represented by the example of FIG. 11.

curl -X POST -H “Content-Type: application/json” -d ′{

“recipient”:{

“id”:“INSTANCE_ID”

},
“message”:{

“attachment”:{

“type”:“image”,
“payload”:{

“url”:“https://sample.com/image.png”

}

}

}

}′
“https://ws.hootsy.com/api/send?access_token=<OBJECT_ACCESS_TOKEN>”

TABLE H

| Property Name | Description | Required |
|---|---|---|
| type | image | Yes |
| payload.url | URL of image | Yes |

Model Attachment

As represented by the exemplary image in FIG. 12, this feature provides for inclusion of a 3D model 230 that is displayed next to the virtual assistant object 120. This attachment type is unique to the Hootsy system. The model 230 is not removed until another model is displayed or the user says the command ‘remove model’. Rescaling of the model may or may not be included (presently not included) and the user can click and drag within the scene to move around this model separate from the assistant 120.

curl -X POST -H “Content-Type: application/json” -d ′{

“recipient”:{

“id”:“INSTANCE_ID”

},
“message”:{

“attachment”:{

“type”:“model”,
“payload”:{

“url”:“https://sample.com/model.gltf”,
“scale”: 1,
“x_position”: 1.5,
“y_position”: 0.5,
“z_position”: 1,
“y_rotation”: 90

}

}

}

}′
“https://ws.hootsy.com/api/send?access_token=<OBJECT_ACCESS_TOKEN>”

TABLE I

| Property Name | Description | Required |
|---|---|---|
| type | model | Yes |
| payload.url | URL of image. Must be a GLTF model. | Yes |
| payload.context | Defines the context that will be | No |
| | sent in a subsequent message if | |
| | the user looks at the model and says | |
| | a new command. | |
| | Managed by the Context Control script | |
| payload.subcontext | Defines the subcontext which are parts | No |
| | of the model that will be sent in a | |
| | subsequent message if the user looks at | |
| | that part of the model and says a new | |
| | command. For example, if user looks at | |
| | the sofa cushion and says ‘what is | |
| | this’. This message is sent with | |
| | context of ‘sofa’ and ‘cushion’. | |
| | Managed by the Context Control script | |
| payload.scale | Scale of model. Defaults to 1. | No |
| payload.x_position | X position of model. Defaults to | No |
| | 0 which is a position far enough | |
| | to the right of the assistant to | |
| | ensure no overlap. | |
| payload.y_position | Y position of model. Defaults to 0 | No |
| | which is ground height. | |
| payload.z_position | Z position of model. Defaults to 0. | No |
| payload.y_rotation | Y rotation of model in degrees. | No |
| | Defaults to 0. | |

Background Attachment

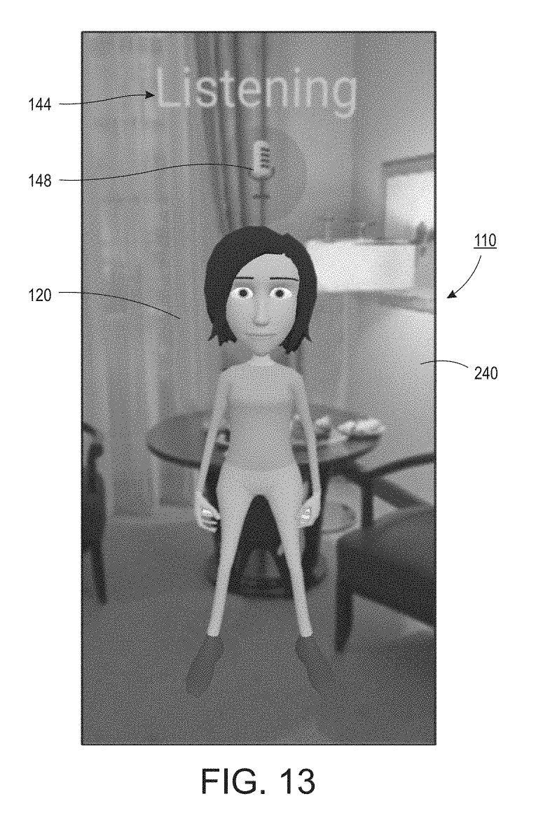

The Background Attachment feature, as represented by FIG. 13, changes the background to display a 360 degree image 240 within the scene 110. This attachment type is unique to the Hootsy system. The background image is not removed until another background image is displayed or the user says the command ‘remove background’.

curl -X POST -H “Content-Type: application/json” -d ′{

“recipient”:{

“id”:“INSTANCE_ID”

},
“message”:{

“attachment”:{

“type”:“background”,
“payload”:{

“url”:“https://sample.com/background_image.png”

}

}

}

}′
“https://ws.hootsy.com/api/send?access_token=<OBJECT_ACCESS_TOKEN>”

TABLE J

| Property Name | Description | Required |
|---|---|---|
| type | background | Yes |
| payload.url | URL of image. Must be a equirectangular | Yes |
| | image. | |

Templates

The templates feature provides the ability for the developer to include, in association with an assistant object, structured message templates supported by the Hootsy system.

Button Template

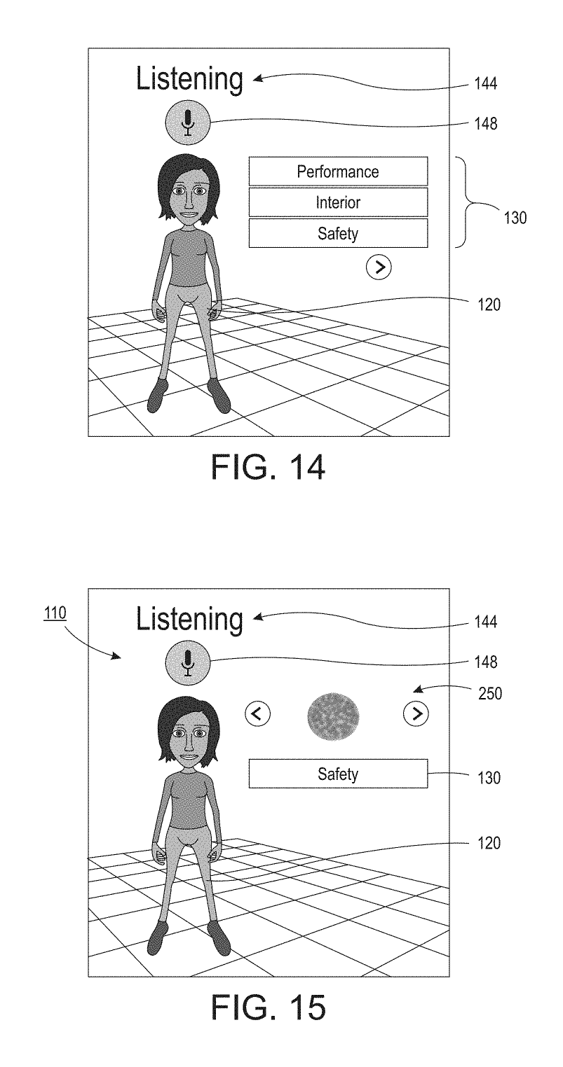

As represented by the example depicted in FIG. 14, for example, button templates provides buttons 130 (e.g., Performance, Interior, Safety) that display adjacent the assistant object 120 and along with spoken text for the object.

curl -X POST -H “Content-Type: application/json” -d ′{

“recipient”:{

“id”:“INSTANCE_ID”

},
“message”:{

“attachment”:{

“type”:“template”,
“payload”:{

“template_type”:“button”,
“text”:“What would you like to know more about?”,
“buttons”:[

{

“type”:“postback”,
“title”:“Performance”,
“payload”:“USER_DEFINED_PAYLOAD_PERFORMANCE”

},
{

“type”:“postback”,
“title”:“Interior”,
“payload”:“USER_DEFINED_PAYLOAD_INTERIOR”

},
{

“type”:“postback”,
“title”:“Safety”,
“payload”:“USER_DEFINED_PAYLOAD_SAFETY”

},
{

“type”:“postback”,
“title”:“Price”,
“payload”:“USER_DEFINED_PAYLOAD_PRICE”

}

]

}

}

}

}′ https://ws.hootsy.com/api/send?access_token=<OBJECT_ACCESS_TOKEN>

Attachment Object

TABLE K

| Property Name | Description | Required |
|---|---|---|
| type | Value must be template | Yes |
| payload | payload of button template | Yes |

Payload Object

TABLE L

| Property Name | Description | Type | Required |
|---|---|---|---|
| template_type | Value must be button | String | Yes |
| text | UTF-8 encoded text of up to 640 | String | Yes |
| | characters | | |
| buttons | Set of one to three buttons that | Array of | Yes |
| | appear as call-to-actions | button | |

Generic Template

As shown, for example, in FIG. 15, this feature facilitates the depiction of a scrollable carousel of items 250 within the VR or AR scene 110.

curl -X POST -H “Content-Type: application/json” -d ′{

“recipient”:{

“id”:“INSTANCE_ID”

},
“message”:{

“attachment”:{

“type”:“template”,
“payload”:{

“template_type”:“generic”,
“elements”:[

{
“title”:“Pepperoni pizza”,
“image_url”:“https://sample.com/pepperoni_image.png”,
“subtitle”:“Classic marinara sauce with authentic old-world style

pepperoni”,

“buttons”:[

{

“type”:“postback”,
“title”:“Select”,
“payload”:“USER_DEFINED_PAYLOAD_SELECT”

}

]

}

]

}

}

}

}′
“https://ws.hootsy.com/api/send?access_token=<OBJECT_ACCESS_TOKEN>”

Attachment Object

TABLE M

| Property Name | Description | Required |
|---|---|---|
| type | Value must be template | Yes |
| payload | payload of generic template | Yes |

Payload Object

TABLE N

| Property Name | Description | Type | Required |
|---|---|---|---|
| template_type | Value must be generic | String | Yes |
| image_aspect_ratio | Image aspect ratio used to | String | Yes |
| | render the images specified | | |
| | by image_url in element | | |
| | objects. Value must be | | |
| | horizontal or square. | | |
| elements | Data for each bubble in | Array of | Yes |
| | message | element | |

* elements is limited to 10;
* horizontal image aspect ratio is 1.91:1 and square image aspect ratio is 1:1

Element Object

TABLE O

| Property Name | Description | Type | Required |
|---|---|---|---|
| title | Spoken by the object. | String | Yes |
| subtitle | Spoken by the object after | String | No |
| | saying the title. | | |
| image_url | Image to display | String | No |
| buttons | Set of buttons that appear | Array of | Mo |
| | as call-to-actions | button | |

* title has an 80 character limit;
* subtitle has an 80 character limit;
* buttons is limited to 3

Buttons

Buttons are supported by the button template and generic template. Buttons provide an additional way for a user to interact with your object beyond spoken commands.

Postback Button

The postback button will send a call to the webhook.

...

“buttons”:[

{

“type”:“postback”,
“title”:“Bookmark Item”,
“payload”:“DEVELOPER_DEFINED_PAYLOAD”

}

]

...

Buttons Fields

TABLE P

| Property Name | Description | Type | Required |
|---|---|---|---|
| type | Type of button. Must be postback. | String | Yes |
| title | Button title. 20 character limit. | String | Yes |
| payload | This data will be sent back to your | String | Yes |
| | webhook. 1000 character limit. | | |

The callback to the webhook will appear as follows:

{

“sender”:{

“id”:“INSTANCE_ID”

},
“recipient”:{

“id”:“PAGE_ID”

},
“postback”:{

“payload”:“DEVELOPER_DEFINED_PAYLOAD”

}

}

URL Button

The URL button opens a webpage. On a mobile device, this displays within a webview. An example use case would be opening a webview to finalize the purchase of items. The button must be selected via click or tap action so it is recommended to indicate this in the virtual assistant's response when displaying these buttons.

...

“buttons”:[

{

“type”:“web_url”,
“title”:“Web Item”,
“url”:“https://samplesite.com”

}

]

...

Buttons Fields

TABLE Q

| Property Name | Description | Type | Required |
|---|---|---|---|
| type | Type of button. Must be web_url. | String | Yes |
| title | Button title. 20 character limit. | String | Yes |
| url | The location of the site you want to | String | Yes |
| | open in a webview. | | |

Quick Replies

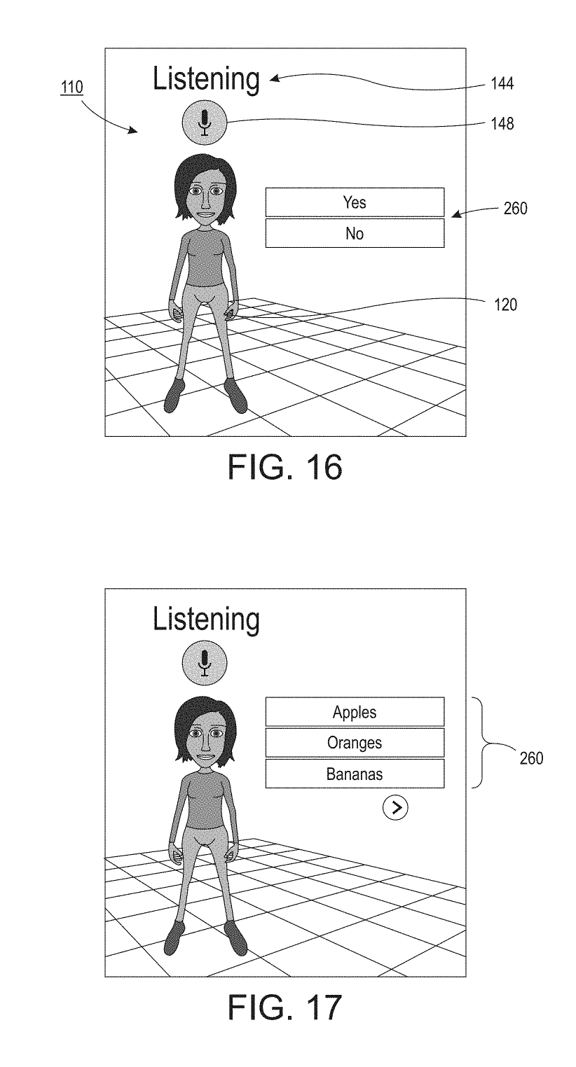

Quick replies, as represented in FIG. 16 for example, display one or more buttons 260 to the user for quick response to a request. They provide an additional way for a user to interact with the virtual assistant object beyond spoken commands.

Message webhook sends to the Hootsy system:

curl -X POST -H “Content-Type: application/json” -d ′{

“recipient”:{
“id”:“INSTANCE_ID”
},

“message”:{
“text”:“Are you hungry?”,
“quick_replies”:[

{

“content_type”:“text”,
“title”:“Yes”,
“payload”:“DEVELOPER_DEFINED_PAYLOAD_FOR_YES”,

},
{

“content_type”:“text”,
“title”:“No”,
“payload”:“DEVELOPER_DEFINED_PAYLOAD_FOR_NO”,

}

]

}

}′
“https://ws.hootsy.com/api/send?access_token=<OBJECT_ACCESS_TOKEN>”

Quick Replies is an array of up to a predefined number (e.g., eleven) of quick_reply objects, each corresponding to a button. Scroll buttons will display when there are more than three quick replies depicted in the scene (see FIG. 17). Example:

Quick_Reply Object

TABLE R

| Property Name | Description | Type | Required |
|---|---|---|---|
| content_type | Only ‘text’ is currently | String | Yes |
| | supported. | | |
| title | Caption of button | String | Yes |
| url | Custom data that will be sent | String | No |
| | back via webhook | | |

* title has a 20 character limit, after that it gets truncated;
* payload has a 1000 character limit

When a Quick Reply is selected, a text message will be sent to the associated webhook Message Received Callback. The text of the message will correspond to the Quick Reply payload.

For example, therResponse sent to your webhook:

{

“sender”: {

“id”: “INSTANCE_ID”

},
“recipient”: {

“id”: “OBJECT_ID”

},
“message”: {

“mid”: “mid.1464990849238:b9a22a2bcb1de31773”,
“text”: “Red”,

}

}

Get Started Message

This message is sent the first time a virtual assistant starts listening. The text of the message is defined when the assistant is created. It is useful if you want to have the assistant initiate a conversation when the user first looks at the assistant object (e.g., target zone) or want to display an additional model along with the assistant.

Interaction Details

Turning now to FIGS. 18A-18I, depicted therein are a series of sequential scenes intended to depict an interactive session between a virtual assistant(s) and a user (not shown) viewing and interacting with the scene in accordance with the disclosed embodiments. As will be appreciated, various features of the assistant generation technique and the display system(s) creating the scenes are also operatively associated with a system selected from one or more computer systems, networked computer systems, augmented reality systems, and virtual reality systems.

Starting with the scene of FIG. 18A, for example, the user of the VR or AR system is presented with an assistant 120 as illustrated, and the system resumes “Listening” by recording the user's verbal instructions as indicated in instruction bar 140. As previously described, the presentation of the virtual assistant 120 in the scene 110 also includes a mode or status indication field 144 (displaying “Listening”), a graphic or icon 148 indicating the assistant status for the (e.g., the microphone is “on” (green background) and the user's voice input is being received and processed). As will be appreciated, for each virtual assistant in the scene, the visual cues are provided to indicate the state of the virtual assistant relative to an assigned user (e.g., looking, listening, paused, loading, etc.) Below the assistant object is status icon 152, showing a graphic representation of the virtual assistant's status (e.g., the gray area with a varying waveform indicates that the assistant is receiving an audio input (the user's speech)). In the absence of user instructions, the instruction bar 140 may prompt the user. For example, a prompt may be “Try saying ‘hello.’”

As FIGS. 18B-18C show, as the user's instruction is received and translated from speech to text, the text form of the instruction is posted and updated within the scene, such as in area 146. Then, once the user's speech is recognized as a complete instruction the color of the text in area 146 is changed (e.g., green) to signal that the assistant app recognized the user's instruction. In other words, the system provides a visual cue to indicate recognition of the instructions. Similar visual cues may include a text-based cue, a facial cue, a color cue (e.g., red, green, yellow), and an iconic cue. For example, in addition to the green color cue in area 146 of FIG. 18D, the assistant may nod its head. As suggested above relative to the Object Settings for the assistant object, the database may include a record for the various cues to be used to interact with the user. Furthermore, the assistant may respond with it's own speech (e.g., “There are lots of great pizza places nearby.”) At the same time, in case the user's instruction was misinterpreted, at any time during the assistant's response the user can tap or select the status icon 152 to stop the assistant and allow a new request or instruction from the user. Furthermore, usage of the virtual assistant by at least one additional display system is also subject to the “design” of the virtual assistant interactions, particularly by information stored in the assistant database, which is a shared Hootsy system database, preferably shared between multiple VR or AR systems.

Continuing with FIGS. 18E and 18F, the instruction “I want to order some pizza” is processed by the client-side and server-side apps, and as a result a “Pizzza Hut” assistant 150 is introduced into the scene 110. Moreover, the assistant may issue a verbal response of “I can help you order your pizza.” And, at the same time the speech is played to the user, the assistant's mouth may move so as to realistically suggest that the assistant is speaking to the user.

In the scene of FIG. 18G, the assistant further instructs the user, saying “Here is a Pizza Hut assistant that can help you order your pizza. Tap the box to load the assistant.” In response to the user tapping the Pizza Hut icon, or simply just gazing at the icon, the second virtual assistant is loaded and depicted in the scene as represented by FIGS. 18H and 18I. The second assistant in scene 110 of FIG. 18I may be a Pizza Hut-specific assistant that is able to facilitate placement of an on-line order. Thus, the scene presents two assistants, but each may be presented with differing characteristics and capabilities.

FIG. 19 is a block diagram of the system for implementing the virtual method using a general purpose system such as a computing device(s) 1900. In one embodiment the general purpose computing device 1900 comprises, any of the clients 330 illustrated in FIG. 19. The general purpose computing device 1900 may comprise a processor 1912, a memory 1914, a virtual assistant sharing module 1918 and various input/output (I/O) devices 1916, such as a display, a keyboard, a mouse, a sensor, a stylus, a microphone or transducer, a wireless network access card, an network (Ethernet) interface, and the like. In one embodiment, an I/O device includes a storage device (e.g., a disk drive, hard disk, solid state memory, optical disk drive, etc.). Furthermore, memory 1914 may include cache memory, including a database that stores, among other information, data representing scene objects and elements and relationships therebetween, as well as, information or links relating to the virtual assistant(s).

It should be understood that the virtual assistant sharing module 1918 can be implemented as a physical device or subsystem that is coupled to a processor through a communication channel. Alternatively, the virtual assistant sharing module 1918 can be represented by one or more software applications (or even a combination of software and hardware, e.g., using Application Specific Integrated Circuits (ASIC)), where the Software is loaded from a network or storage medium (e.g., I/O devices 1916) and operated by the processor 1912 in the memory 1914 of the general purpose computing device 1900. Thus, in one embodiment, the virtual assistant sharing module 1918 can be stored on a tangible computer readable storage medium or device (e.g., RAM, magnetic, optical or solid state, and the like). Furthermore, although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. And, steps or blocks in the accompanying figures that recite a determining operation or involve a decision, do not necessarily require that both branches of the determining operation be practiced. In other words, one of the branches of the determining operation can be deemed as an optional step.

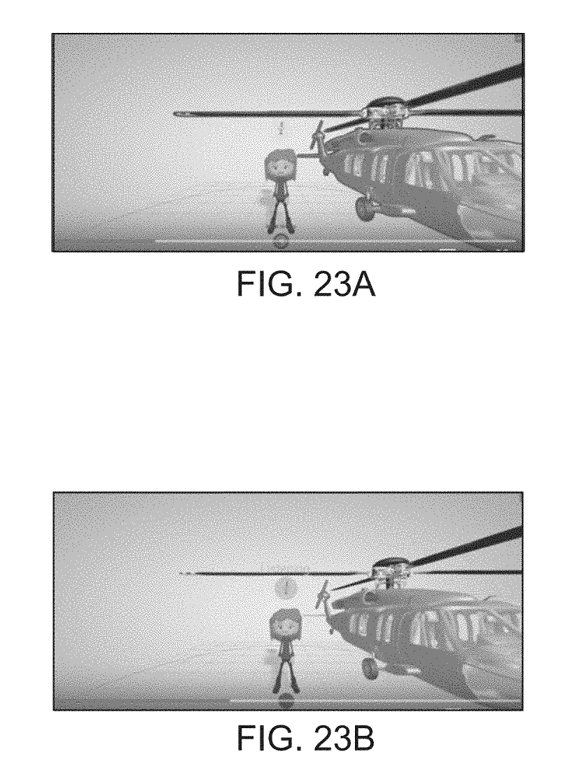

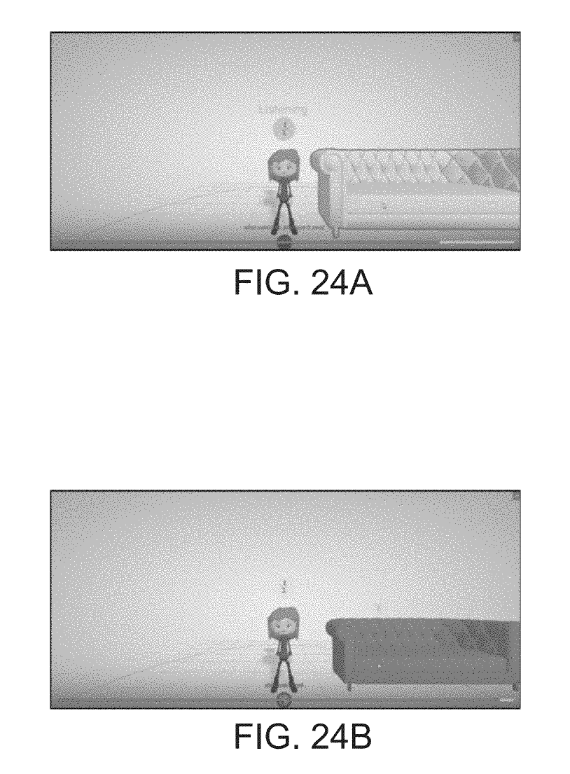

Turning next to FIGS. 23A-24B, depicted therein are a sequence of scenes intended to illustrate the use of a context management feature so that the interactions with a virtual assistant can be related to the content of the scene. More specifically, the Hootsy system and method are able to determine which 3D object in a scene is or provides the context for a given message exchange. Referring to FIG. 23A, for example, if a user looks at an object like a helicopter and says ‘what is this’, as depicted by an outline surrounding the object, the assistant will know the user's question is in reference to the helicopter as the helicopter is the context for the message. As a result, the assistant can respond with ‘this is a helicopter’. It is also possible to define the sub-context for a 3D object, including parts of a 3D model or object. For example, the user could look at the tail rotor and say ‘what is this’ as depicted in FIG. 23B. The sent message will have context of ‘helicopter’ AND ‘tail_rotor’. As a result, the assistant would respond with ‘this is the tail rotor of the helicopter’. Note that in order to illustrate the object viewed, a cursor and outline are employed, but that in an AR/VR setting the system would use the center of the user's screen or other gaze information to determine what the user is looking at—albeit perhaps similarly outlining or otherwise providing a visual indication of the object of interest.

It is also possible to combine the context with the ‘action’ property in the response message to create an infinite number of possible interactions. In the illustration of FIG. 24A, a sofa is displayed (e.g., with a green color), and then the user asks the assistant to see it in red. The context for this is ‘sofa’, and the response back includes an action to ‘replace’ along with details of the 3D object to replace the context object with a sofa depicted in “red” (e.g., sofa in darker shading in FIG. 24B). Using context in natural language processing or voice interaction permits the system to identify the 3D object of interest, as well as parts of that 3D object. As another example, it would be possible to combine this with image recognition for interaction with real world objects. A user could look at a television with an AR device. Image recognition would identify what is in the scene and then would identify the television as the context or ‘object of interest’ about which the user is interacting with the assistant. The user could then say ‘turn on’ and it would know exactly what the user is trying to turn on and would perform that action by turning the television on.

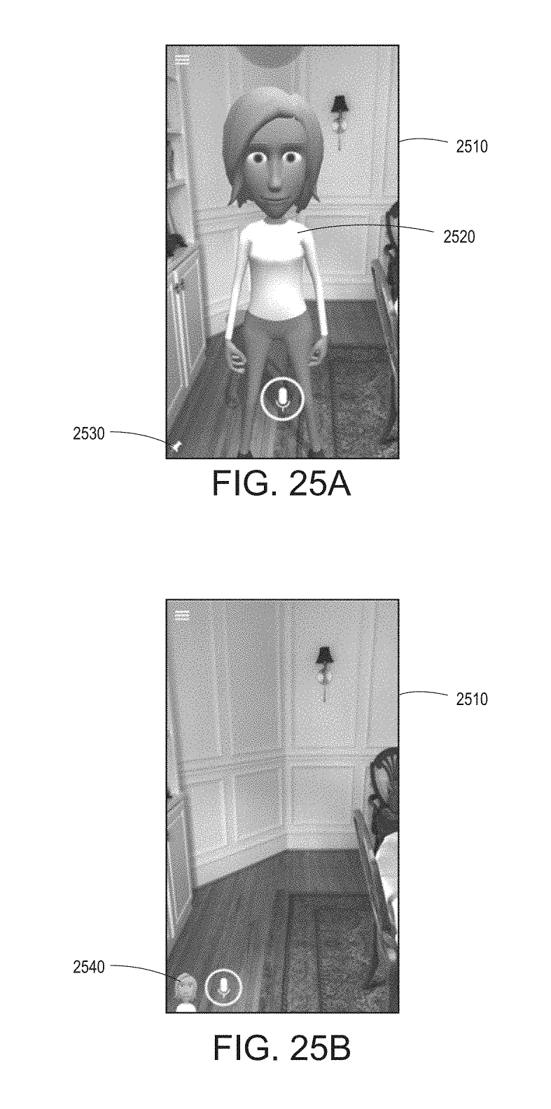

Another alternative or optional feature enabled by the disclosed system and method includes the ability to retain or attach the assistant. Reference is made to FIGS. 25A-25B in order to further describe the detail of the function. In a general sense the function allows a user to walk away from an assistant, yet the user can attach the assistant to the screen (scene) and continue the conversation. For example, if a user was using a Yelp assistant to recommend a nearby restaurant, the user could walk away from the assistant, yet attach the assistant to the screen and continue to talk to the assistant so the assistant could help direct the user to the restaurant. As illustrated in FIGS. 25A-25B, while interacting with the assistant 2520 in the scene 2510, the lower-left corner of the scene includes a pin icon 2530. After tapping the pin icon 2530, as reflected in FIG. 25B the assistant is now attached to the screen (3D assistant model no longer displays in scene, but is fixed in the lower-left corner) and communications with the assistant can continue. In order to restore the assistant to a scene, the user has to simply tap the assistant icon 2540 in the lower-left corner. Also contemplated is a similar use of the system to manage switching between the conversation with the attached assistant and the conversations with a 3D assistant in the scene. As will be appreciated the interaction boundary logic discussed above would no longer be applicable if the user is operating with the assistant attached to the screen.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A computer-implemented method for displaying a plurality of virtual assistants on a display via an application programming interface, comprising:
displaying, within a scene, at least one computer-implemented virtual assistant responsive to voice (audio) commands from a user viewing the scene, wherein at least said virtual assistant is implemented by a first display system including a processor and a memory, with computer code instructions stored thereon, where the processor and the memory are configured to implement the virtual assistant and respond to a user request to initiate dialog with the virtual assistant, said virtual assistant being selected from a database of created virtual assistants, wherein the virtual assistant is a predefined virtual assistant having a unique identifier, and for which a virtual assistant model and associated interaction details are stored in the memory and associated with the database, and where usage of the predefined virtual assistant by the display system is controlled in response to information stored in said database,
updating the database to track usage of the virtual assistant by each display system, wherein tracking usage includes recording, in the database, each virtual assistant occurrence and the assignment of each virtual assistant occurrence;
associating a navigation object (target area) to the at least one computer-implemented virtual assistant responsive to voice (audio) commands, wherein the navigation object is configured to be responsive to at least one predetermined user viewing condition (e.g., ray from user's view intersects with target area); and
detecting when the user is intending to interact with (e.g. looks at) the at least one computer-implemented virtual assistant responsive to voice (audio) commands, and upon detecting the intent to interact, enabling the receipt of the user's voice command(s) by the display system.

2. The method according to claim 1, wherein said virtual assistant is selected from the group consisting of: an object, and an avatar.

3. The method according to claim 1, further comprising
providing the database of created virtual assistants, wherein the at least one virtual assistant is a predefined virtual assistant having a unique identifier, an instance ID associated with the display system, a virtual assistant's ID, a user's ID, and an instance number, and for each occurrence a virtual assistant model and associated interaction details are stored in memory;
wherein a plurality of virtual assistants are displayed within the scene and where at least a portion of the plurality of virtual assistants are from a plurality of sources, and each of said virtual assistants displayed in the scene are associated with a user's ID in said database; and
tracking the exchange of communications between each of the virtual assistants within the scene and their respective users.

4. The method according to claim 1, further comprising:
in response to the user's voice command, displaying within the scene of the display system, a visual object related to the display system's response to the user's voice command.

5. The method according to claim 4, further comprising:
detecting when a user is intending to interact with the visual object, and upon detecting the intent to interact with the visual object, indicating the visual object as an input to the display system.

6. The method according to claim 1, further comprising, for each virtual assistant present in the scene, providing a visual cue to indicate the state of the virtual assistant relative to an assigned user.

7. The method according to claim 7, further comprising a visual cue selected from group consisting of: a text-based cue, a facial cue, a color cue, and an iconic cue.

8. The method according to claim 1, wherein usage of the predefined virtual assistant by at least one additional display system is also controlled by information stored in said database.

9. The method according to claim 1, wherein the display system is operatively associated with a system selected from the group consisting of: a computer system, a networked computer system, an augmented reality system, and a virtual reality system.

10. The method according to claim 3 further comprising:
identifying a context of an object other than a virtual assistant within the environment from the detected at least one of visual and auditory data associated with the scene;
retrieving information relevant to the identified context and applying such information to at least one virtual assistant occurrence; and
proactively displaying the retrieved information, said at least one computer-implemented virtual assistant providing a response relative to the identified context.

11. A non-transitory computer-readable storage device storing a plurality of instructions which, when executed by a processor, cause the processor to perform operations comprising:
displaying, within a scene, at least one computer-implemented virtual assistant responsive to voice (audio) commands from a user viewing the scene, wherein at least said virtual assistant is implemented by a first display system including a processor and a memory, with computer code instructions stored thereon, where the processor and the memory are configured to implement the virtual assistant and respond to a user request to initiate dialog with the virtual assistant, said virtual assistant being selected from a database of created virtual assistants, wherein the virtual assistant is a predefined virtual assistant having a unique identifier, and for which a virtual assistant model and associated interaction details are stored in the memory and associated with the database, and where usage of the predefined virtual assistant by the display system is controlled in response to information stored in said database,
updating the database to track usage of the virtual assistant by each display system, wherein tracking usage includes recording, in the database, each virtual assistant occurrence and the assignment of each virtual assistant occurrence;
associating a navigation object (target area) to the at least one computer-implemented virtual assistant responsive to voice (audio) commands, wherein the navigation object is configured to be responsive to at least one predetermined user viewing condition (e.g., ray from user's view intersects with target area); and
detecting when the user is intending to interact with (e.g. looks at) the at least one computer-implemented virtual assistant responsive to voice (audio) commands, and upon detecting the intent to interact, enabling the receipt of the user's voice command(s) by the display system.

12. The non-transitory computer-readable storage device according to claim 11, further comprising
providing the database of created virtual assistants, wherein the at least one virtual assistant is a predefined virtual assistant having a unique identifier, an instance ID associated with the display system, a virtual assistant's ID, a user's ID, and an instance number, and for each occurrence a virtual assistant model and associated interaction details are stored in memory;
wherein a plurality of virtual assistants are displayed within the scene and at least a portion of the plurality of virtual assistants are from a plurality of sources, each of said virtual assistants displayed in the scene are associated with a user's ID in said database; and
tracking the exchange of communications between each of the virtual assistants within the scene and their respective users.

13. The non-transitory computer-readable storage device according to claim 11, further comprising displaying within the scene of the display system, in response to the user's voice command, a visual object in response to the user's voice command.

14. The non-transitory computer-readable storage device according to claim 13, further comprising detecting when a user is intending to interact with the visual object, and upon detecting the intent to interact with the visual object, indicating the visual object as an input to the display system.

15. The non-transitory computer-readable storage device according to claim 11, further comprising, for each virtual assistant present in the scene, providing a visual cue to indicate the state of the virtual assistant relative to an assigned user.

16. The non-transitory computer-readable storage device according to claim 15, further comprising a visual cue selected from group consisting of: a text-based cue, a facial cue, a color cue, and an iconic cue.

17. The non-transitory computer-readable storage device according to claim 11, where usage of the predefined virtual assistant by at least one additional display system is also controlled by information stored in said database.

18. The non-transitory computer-readable storage device according to claim 11, wherein the display system is operatively associated with a system selected from the group consisting of: a computer system, a networked computer system, an augmented reality system, and a virtual reality system.

19. The non-transitory computer-readable storage device according to claim 12 further comprising:
identifying a context of an object other than a virtual assistant within the environment from the detected at least one of visual and auditory data associated with the scene;
retrieving information relevant to the identified context and applying such information to at least one virtual assistant occurrence; and
proactively displaying the retrieved information, said at least one computer-implemented virtual assistant providing a response relative to the identified context.
